(19) United States
(12) Patent Application Publication
(10) Pub. No.: US 2011/0261091 A1
(43) Pub. Date: Oct. 27, 2011

(54) DISPLAY DEVICE AND COMPUTER READABLE MEDIUM

(75) Inventor: Masaki NOSE, Kawasaki (JP)

(73) Assignee: Fujitsu Limited, Kawasaki (JP)

(21) Appl. No.: 13/175,101

(22) Filed: Jul. 1, 2011

Related U.S. Application Data
(63) Continuation of application No. PCT/JP2009/052751, filed on Feb. 18, 2009.

(51) Int. Cl. G09G 3/36; G09G 5/10

(52) U.S. Cl. 345/690; 345/89

(57) ABSTRACT

A display device includes: a data storage unit that stores image data; a display image data generation unit that generates display image data by adding a noise pattern, of which a polarity is in accordance with a gray level value of each pixel of the image data, to the image data; and a display unit that displays an image based on the display image data generated by the display image generation unit.

### CROSS-REFERENCE TO RELATED APPLICATION

This application is a continuation application of PCT/JP2009/052751 filed Feb. 18, 2009, the contents of which are herein wholly incorporated by reference.

### FIELD

A certain aspect of the embodiments discussed herein is related to a display device and a computer readable medium.

### BACKGROUND

Recently, various enterprises and universities are actively engaged in the development of electronic paper. Multiple ways of application of electronic paper, such as electronic books, sub-displays of mobile terminals, displays of IC cards and the like, are proposed. One of display methods for electronic paper is cholesteric liquid crystals utilizing liquid crystal compositions which form a cholesteric phase. Cholesteric liquid crystals are also called chiral nematic liquid crystals, and are liquid crystals where molecules of nematic liquid crystals form a helical cholesteric phase by adding relatively large amount (several tens percent) of chiral additives (chiral materials) to nematic liquid crystals. Cholesteric liquid crystals have excellent characteristics, such as memory characteristics capable of maintaining a display semi-permanently, vivid color display characteristics, high-contrast ratio characteristics, high-resolution characteristics and the like.

More specifically, cholesteric liquid crystals have bi-stability (memory characteristics), and take one of a planer state, a focal conic state, and an intermediate state where a planer state and a focal conic state coexist, by adjusting the intensity of electric field applied to liquid crystals. Once the liquid crystal enters a planar state or a focal conic state, the state is thereafter kept with stability even when no electric power is supplied.

A planer state is obtained by applying a predetermined high voltage to a liquid crystal to apply a strong electric field to the same and thereafter nullifying the electronic field abruptly. For example, a focal conic state is obtained by applying a predetermined voltage lower than the above-described high voltage to the liquid crystal to apply an electric field to the same and thereafter nullifying the electric field abruptly. The intermediate state where a planer state and a focal conic state coexist is obtained by, for example, applying a voltage lower than the voltage for obtaining the focal conic state to the liquid crystal to apply an electric field to the same and thereafter nullifying the electric field abruptly.

A liquid crystal display element utilizing cholesteric liquid crystals has display memory characteristics as described above, and is good for being used to memory-display a same image for long period of time. However, if the liquid crystal display element displays an image for long period of time, when changing the image being displayed to a next image, there is a possibility of the occurrence of so-called image sticking, which means that the previously displayed image sticks as an after-image.

Affinity between moisture, ionic impurities or liquid crystals and substrate interfaces and the like are considered as the cause of image sticking. In order to prevent image sticking, very high stability is required in the degree of refinement of a liquid crystal material, the state of interfaces, and the like. To alleviate image sticking, a method of mitigating image sticking as thus described has been proposed as follows. A timer and an optical sensor are provided to measure and detect elapsed time and the brightness of the environment of a screen, and the screen is put in a standby state (the display is turned off) depending on detection results to prevent image sticking (e.g. see Japanese Laid-open Patent Publication No. 2004-4200).

It is understood that a cholesteric liquid crystal is subjected to a higher degree of image sticking as the ambient temperature of the same becomes high. Another method has been proposed as follows based on this understanding. The ambient temperature of a liquid crystal display element is acquired. When a temperature increase or temperature change in unit time greater than a predetermined value is detected, image sticking is prevented by putting the screen in a standby state or displaying an image sticking preventing pattern using the focal conic state in which the entire screen is rendered black (e.g. see Japanese Laid-open Patent Publication No. 2004-219715).

Another proposed approach to the prevention of image sticking is as follows. While an image is displayed in a memorized display mode, refreshing (rewriting) is carried out each time a predetermined time interval passes by executing a sequence of applying a voltage to the cholesteric liquid crystal to align the cholesteric liquid crystal substantially parallel to the voltage applying direction and thereafter re-displaying the image which has been displayed (e.g. see Japanese Laid-open Patent Publication No. 2002-139746).

### SUMMARY

According to an aspect of the present invention, there is provided a display device including: a data storage unit that stores image data; a display image data generation unit that generates display image data by adding a noise pattern, of which a polarity is in accordance with a gray level value of each pixel of the image data, to the image data; and a display unit that displays an image based on the display image data generated by the display image generation unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a schematic configuration of a liquid crystal display element;

FIG. 2 is a diagram schematically illustrating a structure (cross-section structure) of a display unit in FIG. 1;

FIG. 3A and FIG. 3B are diagrams illustrating a display principle of cholesteric liquid crystals;

FIG. 4A through FIG. 4C are diagrams illustrating voltage response characteristics of cholesteric liquid crystals;

FIG. 5 is a diagram illustrating a display process to the display unit;

FIG. 6 is a diagram illustrating a voltage setting when resetting;

FIG. 7 is a diagram illustrating a voltage setting when writing grayscale;

FIG. 8A and FIG. 8B are diagrams illustrating a display state of the display unit when image sticking occurs;

FIG. 9A is a diagram schematically illustrating a noise pattern image, and

FIG. 9B is a diagram schematically illustrating image data;

FIG. 10 is a diagram illustrating the identifiability of image sticking according to display images of which gray levels are different from each other;

FIG. 11 is a diagram illustrating image sticking characteristics in the display unit;

FIG. 12 is a diagram schematically illustrating an output in a case where a gradation image is an input image;

FIG. 13A and FIG. 13B are diagrams illustrating basic waveforms used in an embodiment;

FIG. 14A and FIG. 14B are diagrams illustrating parameters used in the embodiment;

FIG. 15 is a flowchart illustrating a method of processing an input image in the embodiment;

FIG. 16 is a flowchart illustrating the method of processing an input image in the embodiment;

FIG. 17 is a diagram illustrating a tangible example of the process in FIG. 15;

FIG. 18 is a diagram illustrating a tangible example of the process in FIG. 15;

FIG. 19 illustrates a program (C language) for achieving the process in FIG. 15;

FIG. 20A through FIG. 20C illustrate evaluation standards for an improvement in image sticking, the degree of granularity, and a contrast ratio/color;

FIG. 21 is a diagram illustrating results of subjective evaluation;

FIG. 22 is a diagram illustrating a liquid crystal display element capable of color display;

FIG. 23 illustrates a program (C language) for achieving a process in the liquid crystal display element capable of color display; and

FIG. 24 is a diagram illustrating blue noise.

### DESCRIPTION OF EMBODIMENTS

As described previously, multiple methods for preventing image sticking are proposed. However, in the case of the methods of preventing image sticking by putting a display screen in a standby state or displaying an image sticking preventing pattern on a display screen, a memorized display state must be once terminated to execute such methods. As a result, the liquid crystal display element needs a long time to recover from the standby state or the state of displaying an image sticking prevention pattern and to display the image which has been displayed in the memorized state of display again.

In the case of the method of preventing image sticking by carrying out refreshing by temporarily interrupting a memorized state of display each time a predetermined time interval passes, the liquid crystal display element will consume electric power for the refreshing operation. Further, the display of an image may be interrupted by the refreshing operation while the user of the liquid crystal display element is viewing the screen.

There is a trade-off relationship between an image sticking and a visual quality (contrast ratio). That is to say, an image sticking tends to occur in a display element of which the contrast ratio is high, and the contrast ratio of the element where the image sticking does not easily occur tends to be low. Thus, it is difficult to improve both the image sticking and the contrast ratio by changing a panel structure or materials.

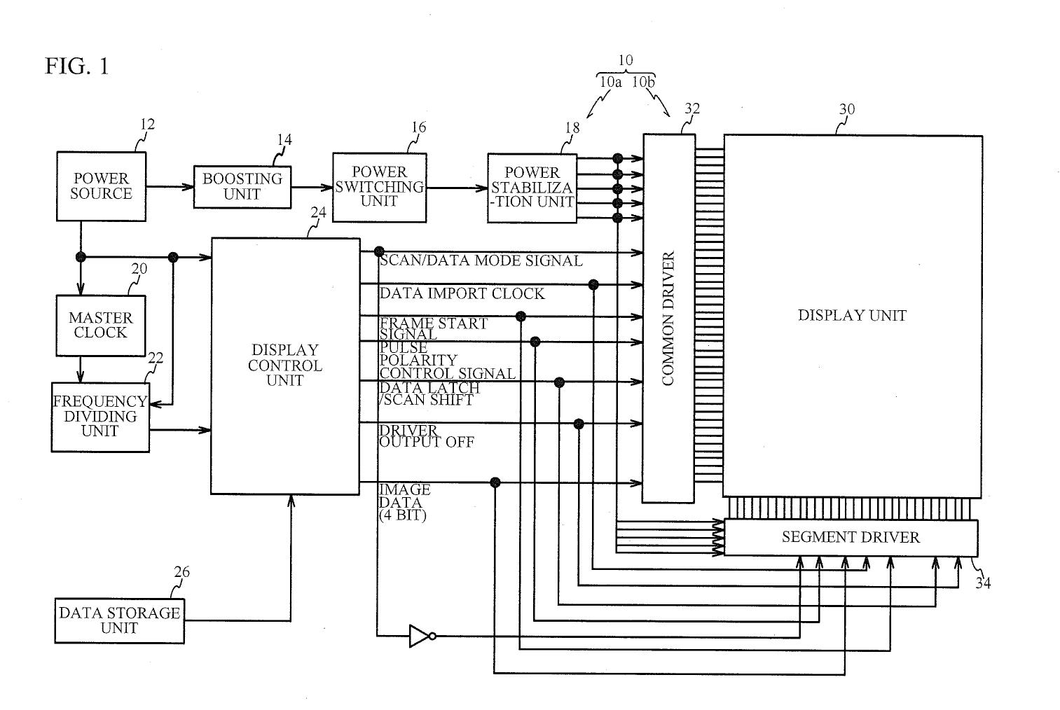

A description will now be given of an embodiment of a present invention with reference to FIG. 1 through FIG. 21.

In FIG. 1, a schematic configuration of a liquid crystal display element 10 as a display device utilizing cholesteric liquid crystals capable of memory-displaying an image without power supply is illustrated by a block diagram. The liquid crystal display element 10 in FIG. 1 is a liquid crystal display element displaying a monochrome image.

The liquid crystal display element 10 is provided with a circuit block 10a and a display block 10b. The circuit block 10a includes a power source 12, a boosting unit 14, a power switching unit 16, a power stabilization unit 18, a master clock 20, a frequency dividing unit 22, a display control unit 24 as a display image data generation unit, and a data storage unit 26. The display block 10b includes a display unit 30, a scan electrode drive circuit (common driver) 32, and a data electrode drive circuit (segment driver) 34.

The power source 12 outputs a DC voltage ranging from 3 to 5 V. The boosting unit 14 includes a DC-DC converter for example, and boosts the DC voltage ranging from 3 to 5 V inputted from the power source 12 to a DC voltage in a range from about 10 to about 40 V required for driving the display unit 30. The boosting unit 14 of which the conversion efficiency to the characteristics of the display unit 30 is high is preferable to be used. The power switching unit 16 generates necessary multi level voltages which depend on a gray level value of each pixel and depend on whether each pixel is selected or not using the voltage boosted by the boosting unit 14 and the input voltage. The power stabilization unit 18 includes a zener diode, an operation amplifier and the like. It stabilizes voltages generated by the power switching unit 16, and supplies them to the common driver 32 and the segment driver 34 provided to the display block 10b. The power source 12 supplies predetermined voltages to the display control unit 24, the master clock 20, and the frequency dividing unit 22 in addition to the boosting unit 14. The frequency dividing unit 22 divides the clock input from the master clock 20 with given frequency dividing rate and outputs it to the display control unit 24 to switch scan speed.

The display control unit 24 includes a processor and the like, and controls the whole of the liquid crystal display element 10. The display control unit 24 displays an image by switching scan speed and a drive voltage (drive pulse) of the display unit 30 via the common driver 32 and the segment driver 34, and executes a reset process of a display region.

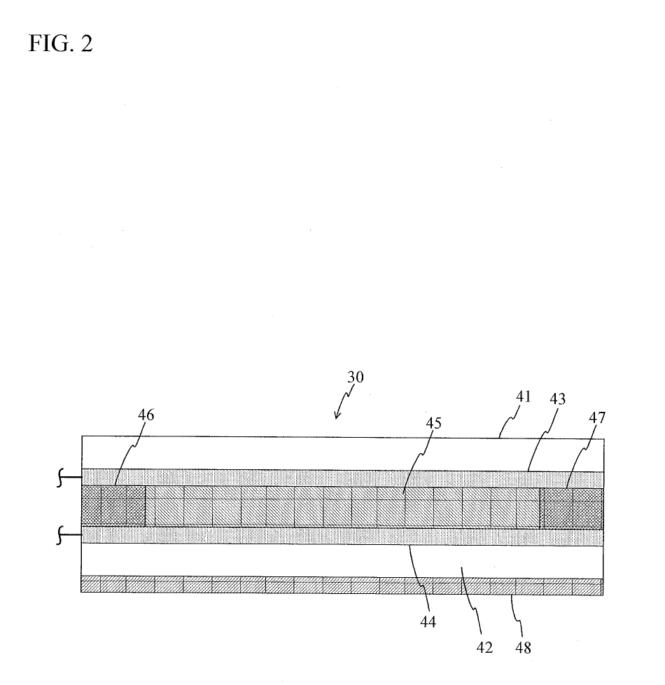

More specifically, the display control unit 24 controls the display unit 30 with a line-sequential drive system which scans linear electrodes 43 and 44 aligned at almost equal interval in the display unit 30 (see FIG. 2). The display control unit 24 controls the scan speed of the common driver 32 to change the application period for which a voltage of the drive pulse is applied. The display control unit 24 controls the segment driver 34 to output a given voltage based on the image data to the display unit 30 in synchronization with a scan timing of the common driver 32.

The display control unit 24 synchronizes generated drive data with data read clock signal and outputs it to the common driver 32 and the segment driver 34. The display control unit 24 changes the scan speed by outputting the drive data to the common driver 32. Moreover, the display control unit 24 outputs control signals, such as a scan/data mode signal, a data import clock signal, a frame start signal, a pulse polarity control signal, a data latch/scan shift signal, and a driver output off signal, to the common driver 32 and the segment driver 34.

FIG. 2 schematically illustrates a structure (cross section structure) of the display unit 30. As illustrated in FIG. 2, the display unit 30 is provided with film substrates 41 and 42, ITO electrodes 43 and 44, liquid crystal compositions 45, seal materials 46 and 47, and an absorbing layer 48.

Film substrates 41 and 42 have translucency. Glass substrates can be used as materials for film substrates 41 and 42, and film substrates such as PET (Polyethylene Terephthalate) and PC (Polycarbonate) may be also used. An alignment film with a pretilt angle of about 0.5 to 8° is provided to a film substrate for example.

ITO electrodes 43 and 44 are composed of multiple belt-like electrodes parallel-aligned. The ITO electrode 43 and the ITO electrode 44 are aligned as to cross each other at 90 degrees from the view of the direction vertical to film substrates 41 and 42 (the direction vertical to the paper surface of FIG. 2). A material to four ITO electrodes 43 and 44 is an Indium Tin Oxide (ITO). Alternatively, electrodes using a transparent conductive film made of an Indium Zic Oxide (IZO) may be used.

A thin film with insulation properties is formed on ITO electrodes 43 and 44. When this insulating thin film is thick, the rise of the drive voltage occurs, and a control by a general STN driver becomes difficult. On the other hand, if the insulating thin film is not provided, the leakage current flows, and the power consumption increases. The relative permittivity of the insulating thin film is around 5, and is lower than that of liquid crystals. Thus, it is preferable that the thickness of the insulating thin film is equal to or less than 0.3 μm. An SiO₂ thin film and an organic film, such as polyimide resin and acryl resin which are well known as an alignment stabilization film, may be used as this insulating thin film.

Liquid crystal compositions 45 are cholesteric liquid crystal compositions exhibiting a cholesteric phase at room temperature. Assume that liquid crystal compositions 45 are cholesteric liquid crystals made by adding 10 to 40 wt % of chiral materials to nematic liquid crystal compositions. The additive amount of chiral materials represents the value in a case where the sum of nematic liquid crystal compositions and chiral materials is 100 wt %. Materials conventionally known can be used as nematic liquid crystals, but it is preferable that its dielectric constant anisotropy (Δ∈) is in a range from 15 to 35. If the dielectric constant anisotropy is equal to or greater than 15, the drive voltage becomes relatively low, and if it exceeds 35, the drive voltage itself is low but the specific resistance becomes small, and the power consumption at high temperature especially increases. Moreover, it is preferable that the refractive index anisotropy (Δn) is in a range from about 0.18 to about 0.24. When the refractive index anisotropy is smaller than the value in this range, the reflection ratio in a planer state becomes low, and when it is greater than the value in this range, the scattering reflection in a focal conic state becomes large. In addition, as this makes the viscosity thick, the response speed is reduced.

Seal materials 46 and 47 seal liquid crystal compositions 45 between film substrates 41 and 42.

The absorbing layer 48 is located on the back side of the film substrate 42 which is the opposite side (the downside of the paper in FIG. 2) of the side to which the light enters (the upper side of the paper in FIG. 2).

A spacer may be provided to the display unit 30 to keep the gap between film substrates 41 and 42 evenly. A spherical object made of resin or inorganic oxide can be used as this spacer. Moreover, a fixed spacer of which the surface is coated with thermoplastic resin may be used as the spacer. It is preferable that the gap formed by the spacer is in a range from 3.5 to 6 μm for example. When the gap is smaller than the value in this range, the reflection ratio decreases and the display becomes dark. When the gap is greater than the value in this range, a drive voltage rises and the drive by general-purpose components becomes difficult.

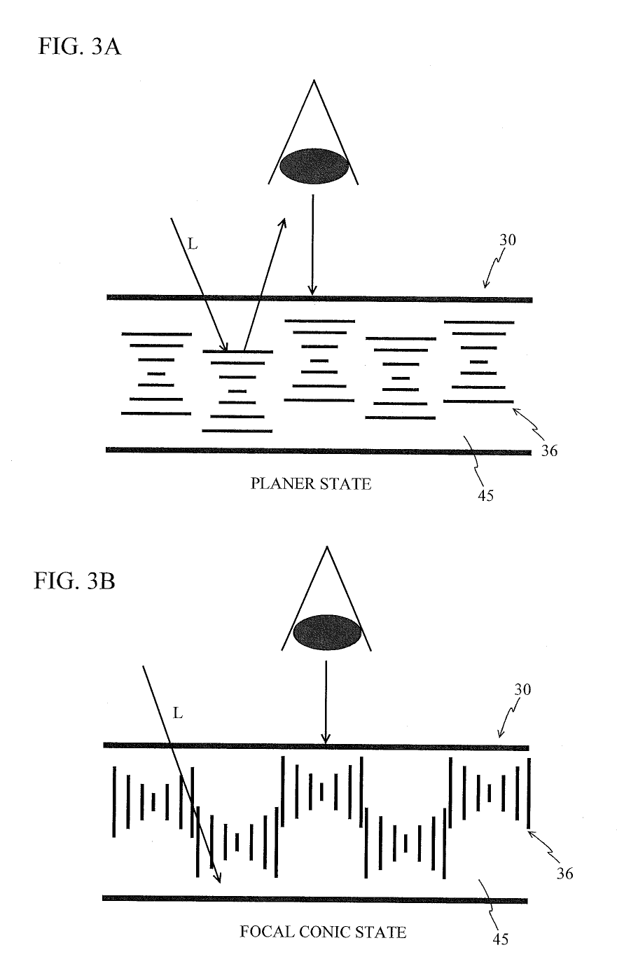

Here, a description will be given of the display principle of cholesteric liquid crystals based on FIG. 3A and FIG. 3B. FIG. 3A illustrates the orientational state of liquid crystal molecules 36 in a case where liquid crystal compositions 45 of the display unit 30 are in a planer state. FIG. 3B illustrates the orientational state of liquid crystal molecules 36 in a case where liquid crystal compositions 45 of the display unit 30 are in a focal conic state.

As illustrated in FIG. 3A, in a planar state, the liquid crystal molecules 36 are sequentially rotated in the thickness direction to form helical structures, and the helical axes of the helical structures become substantially perpendicular to substrate surface. In a planar state, the incident light L having predetermined wavelength in accordance with the helical pitch of the liquid crystal molecules is selectively reflected by the liquid crystal layer. When supposing that the average refractive index of the liquid crystal layer is n and the helical pitch is p, the wavelength λ with which the reflection becomes maximum is expressed with a following formula (1).

λ=n·p (1)

Therefore, in order to reflect the light selectively in liquid crystal compositions 45 of the display unit 30 in a planer state, the average refractive index n and the helical pitch p are determined so that λ, becomes a given value. The average refractive index n can be adjusted by selecting the liquid crystal material and the chiral material, and the helical pitch p can be adjusted by adjusting the chiral material content.

On the other hand, as illustrated in FIG. 3B, in a focal conic state, liquid crystal molecules 36 are sequentially rotated in an in-plane direction of the substrate to form helical structures, and helical axes becomes substantially parallel to the substrate surface. In this case, the display unit 30 loses the selectivity of wavelengths to be reflected, and transmits most of the incident light L.

As described above, in the cholesteric liquid crystal, it is possible to control the reflection/transmission of the incident light L with the orientational state of helically-twisted liquid crystal molecules 36. In addition, in the display unit 30, when the incident light L is transmitted, as the transmitted light is absorbed in the absorbing layer 48 illustrated in FIG. 2, the dark display is achieved.

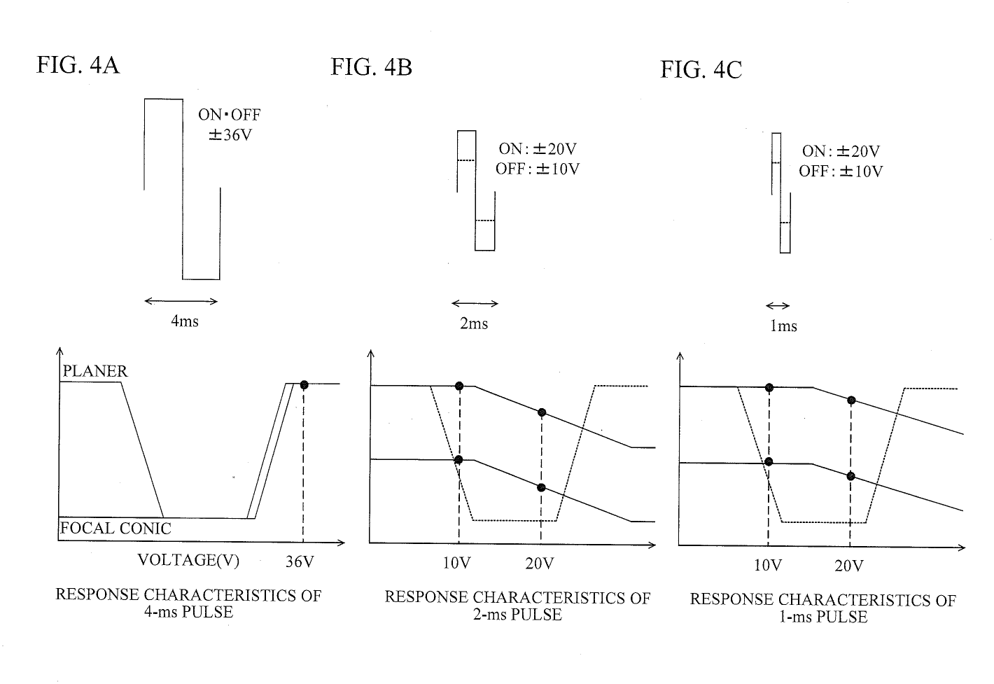

Voltage response characteristics of cholesteric liquid crystals are illustrated in FIG. 4A through FIG. 4C. Assume that the drive waveform is alternating-current waveform to suppress the deterioration of the liquid crystal material in the same manner as general liquid crystals, when cholesteric liquid crystals are driven by a dot matrix.

As illustrated in FIG. 4A, if the initial state is a planer state, the driving band for a focal conic state is achieved when the pulse voltage is raised to a certain range, and the driving band for a planer state is again achieved when the pulse voltage is further raised. Moreover, if the initial state is a focal conic state, the driving band for a planer state is gradually achieved as the pulse voltage is raised. In this case, when the initial state is either a planer state or a focal conic state, the voltage achieving a planer state is ±36 V. Therefore, the intermediate gray level where a planer state and a focal conic state coexist can be obtained at the voltage between −36 V and +36 V.

On the other hand, when the pulse of which the voltage is lower than that of FIG. 4A or of which the period is shorter than that of FIG. 4A is applied, the responsiveness shifts. For example, if the applied pulse is the pulse of which the applied voltage is ±20 V or ±10 V and of which the period is 2 ms or 1 ms, and the initial state is a planer state, the responsiveness does not appear in either cases where the period is 2 ms (FIG. 4B) or the period is 1 ms (FIG. 4C) when the voltage is ±10 V, and a planer state is maintained. On the other hand, when the voltage is ±20 V, in both cases where the period is 2 ms and the period is 1 ms, the responsiveness appears, and the intermediate gray level where the reflection ratio slightly decreases is achieved. As the descent of the reflection ratio when the period is 2 ms is greater than that when the period is 1 ms as understood from the comparison between FIG. 4B and FIG. 4C, the gray level when the period is 2 ms becomes lower than the gray level when the period is 1 ms.

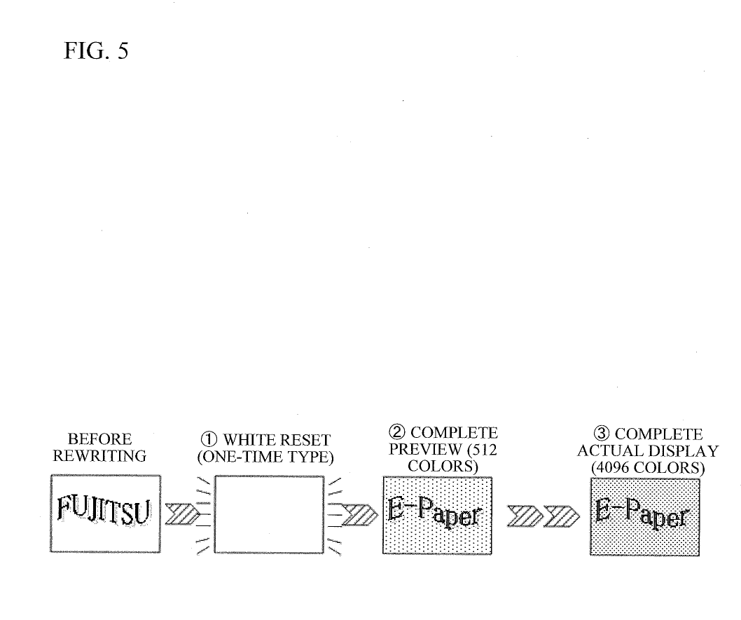

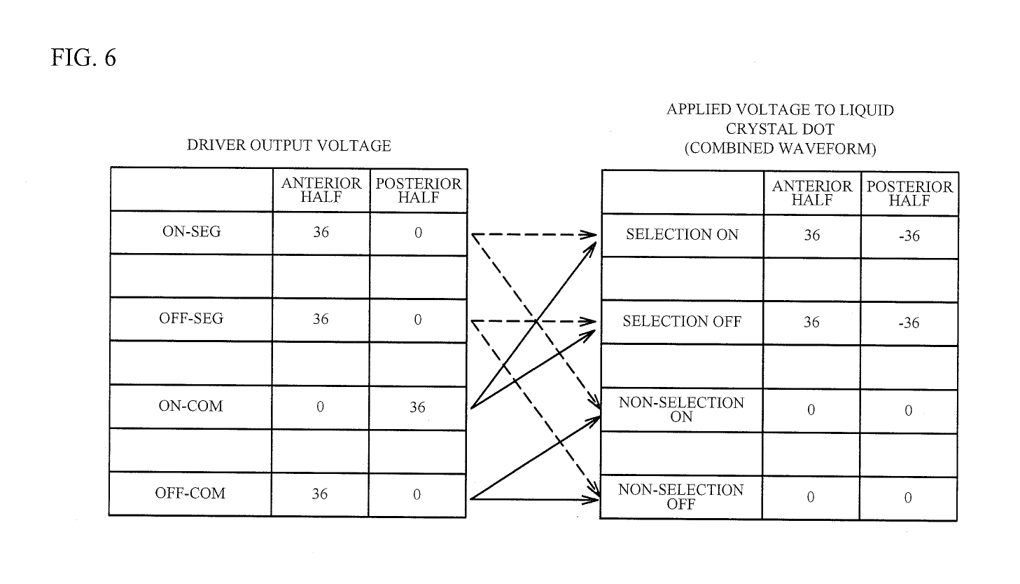

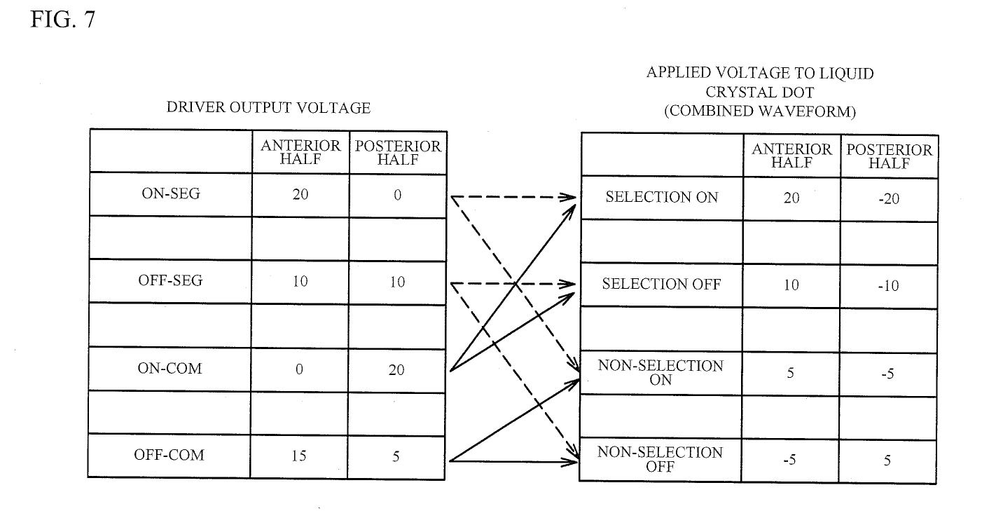

Here, in this embodiment, when carrying out a display to the display unit 30, a desired image is drawn by increasing the ratio of a focal conic state after resetting the pixels to be rewritten to the planer state (white reset) as illustrated in FIG. 5. When a reset is carried out, the voltage setting illustrated in FIG. 6 is carried out. As ±36 V is applied to the selected line with the voltage setting illustrated in FIG. 6, the selected line is reset to a planer state. In addition, when writing grayscale, the voltage setting illustrated in FIG. 7 is carried out. In this case, when writing desired gray level at ±20 V, ±20 V is applied to pixels where scan-side is selected and data-side is ON, ±10 V is applied to pixels where scan-side is selected and data-side is OFF, and ±5 V is applied to pixels where scan-side is not selected. Here, in pixels to which ±10 V or ±5 V is applied, gray levels are not newly formed.

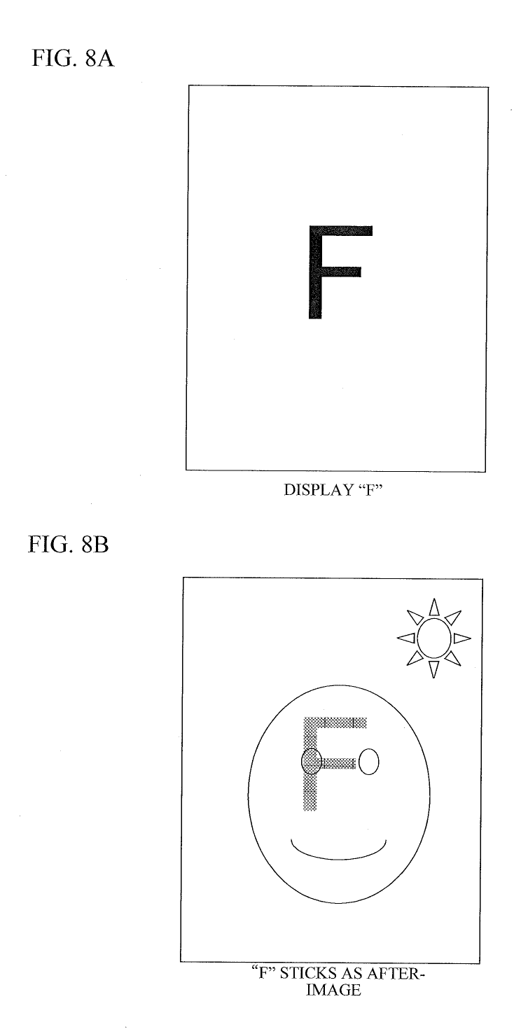

A description will now be given of a method of displaying the image to the display unit 30 in this embodiment with reference to FIG. 8A through FIG. 12. Hereinafter, the pixel value of each pixel forming the display unit 30 is a digital value on 8-bit operation (0 through 255), and the gray level is defined as the number of color levels (256 gray levels at 8 bits, 0 represents black (shadow), 255 represents white (highlight), and values between 0 and 255 represent grayscale).

In this embodiment, when the image is switched after the alphabet “F” is displayed on the display unit 30 for long period of time as illustrated in FIG. 8A, the display method for obscuring the image sticking of the alphabet “F” illustrated in FIG. 8B is carried out.

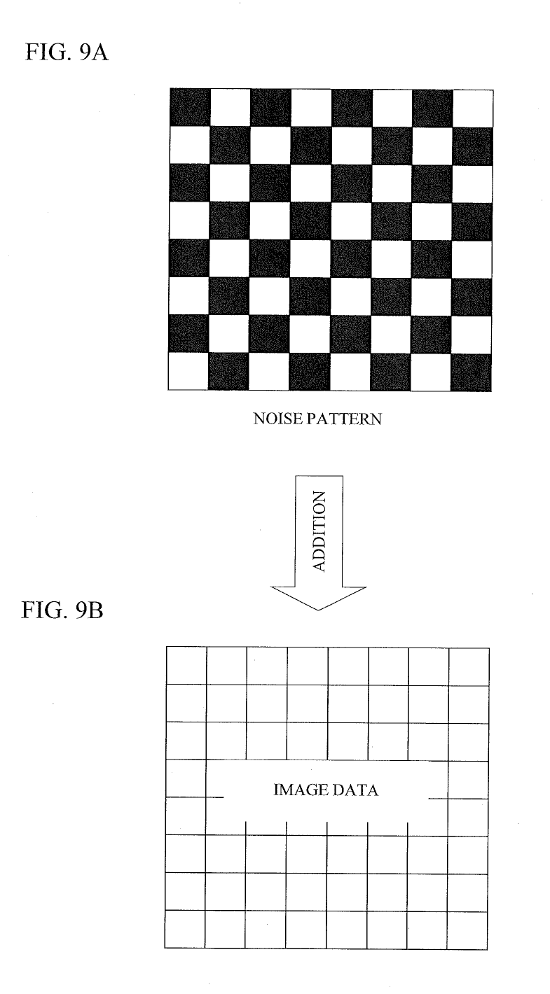

More specifically, the display control unit 24 in FIG. 1 combines a noise pattern image illustrated in FIG. 9A with an image to be displayed illustrated in FIG. 9B, and displays the combined image on the display unit 30.

Here, assume that the noise pattern image is a periodic noise pattern (check pattern) with no correlation to the image to be displayed, and the noise pattern has high frequency (0.5 cycle/pixel). In FIG. 9A, for convenience sake of illustration, the noise pattern image is a monochrome pattern, but actually has imperceptible amplitude from less than one gray level to several gray levels at a maximum.

Even though the noise pattern is combined, as the noise pattern is very small, the disturbance of the image which affects on the visibility (disturbance of gamma characteristic) does not occur.

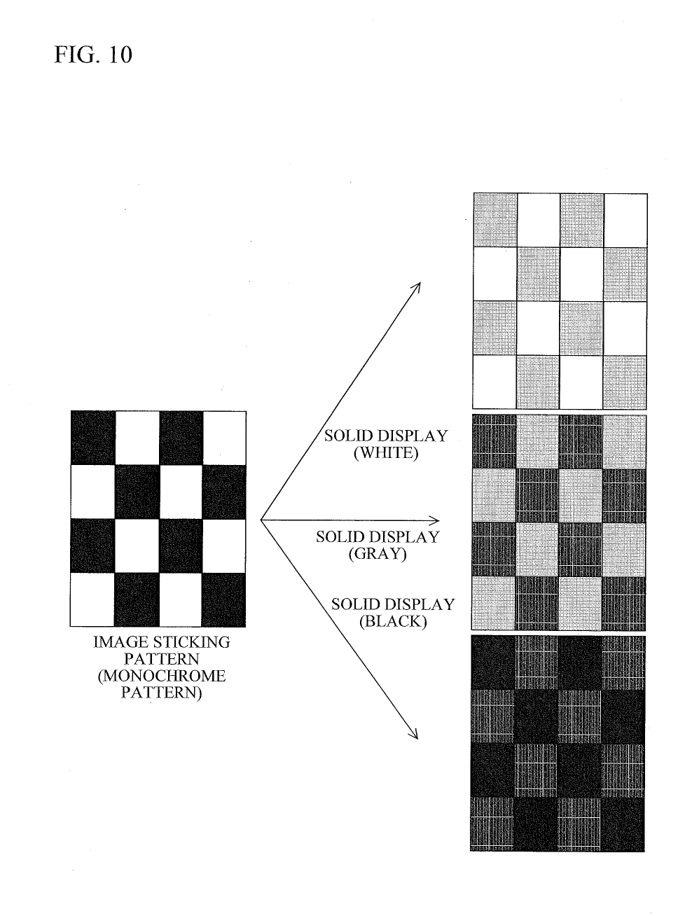

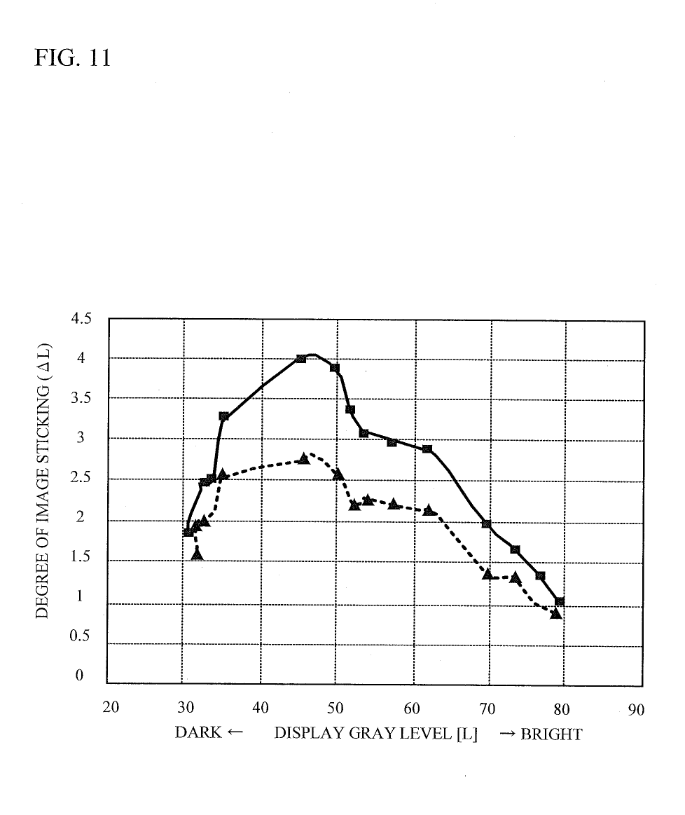

Here, the identifiability of image sticking depends on gray levels of image to be displayed. More specifically, when a white (highlight), gray, or black (shadow) solid pattern is displayed on the display unit 30 after the monochrome pattern illustrated in FIG. 10 is purposely displayed for several days, the monochrome pattern is identified as a sticking image, but the identifiability of the sticking image (the amount of image sticking) is different with respect to the gray levels of solid pattern. The experimental results of the identifiability of the sticking image (degree of image sticking (ΔL)) is illustrated in FIG. 11. In FIG. 11, the degree of image sticking (ΔL) is expressed by the difference of the reflection lightness (L) between the bright region and the dark region. In addition, a solid line illustrates a case where a period for which the monochrome pattern is displayed is long (e.g. 3 days), and a dashed line illustrates a case where a period for which the monochrome pattern is displayed is short (e.g. 1 day).

According to the graph in FIG. 11, as the gray level value of the image to be displayed is closer to the intermediate gray level (gray), the amount of image sticking tends to be larger. As the gray level value is closer to white (highlight) or black (shadow), the amount of image sticking tends to be smaller. Therefore, it is considered that in order to obscure the image sticking in each pixel of the image, amplitudes of gray level values of the noise pattern are made larger as gray level values of the image to be displayed are closer to the intermediate gray level, and amplitudes of gray level values of the noise pattern are made smaller as gray level values of the image to be displayed are closer to the highlight or shadow. In addition, it is considered that the image sticking and the visual quality (contrast ratio) are improved simultaneously by displaying the highlight pixel corrected to be more highlight, and displaying the shadow pixel corrected to be more shadow.

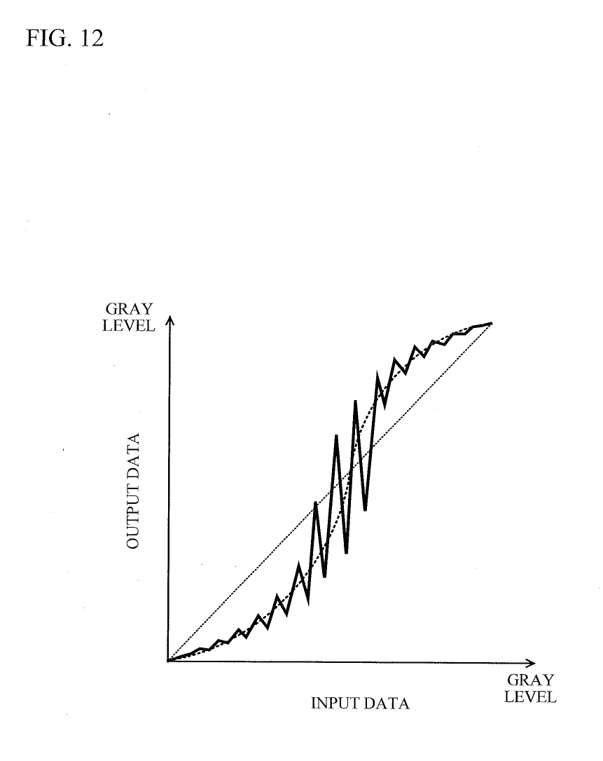

FIG. 12 is a schematic diagram conceptually-illustrating a method of adding a noise pattern in this embodiment, and illustrates output data in a case where input data is a gradation image where gray levels gradually change from dark to bright. As illustrated in FIG. 12, in this embodiment, the amplitude is made larger as the gray level is closer to the intermediate gray level, the polarity is set to the negative polarity in a case of dark gray level, and the polarity is set to the positive polarity in a case of bright gray level.

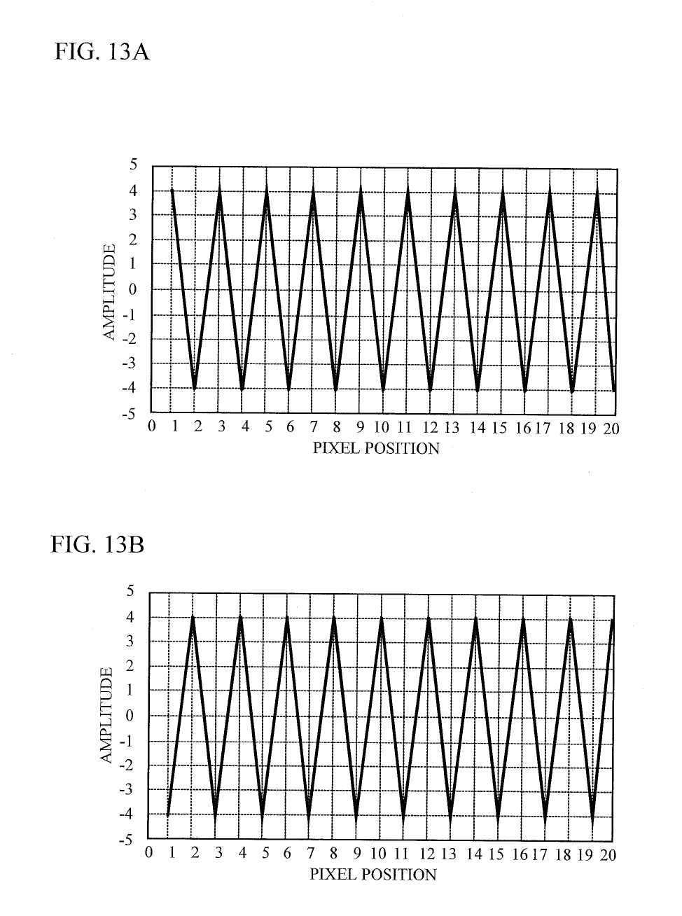

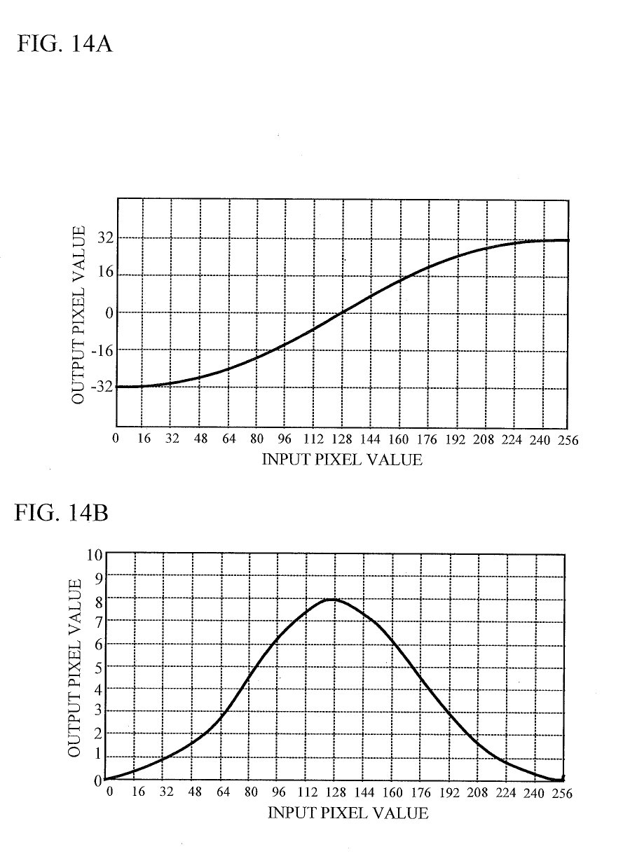

Hereinafter, a description will be given of a tangible method for executing the process illustrated in FIG. 12. In this process, graphs (parameters) illustrated in FIG. 13A through FIG. 14B are used. FIG. 13A and FIG. 13B illustrate basic waveforms (carrier) for forming a noise pattern (check pattern). There are two basic waveforms as illustrated in FIG. 13A and FIG. 13B, and they are used according to the column number of the pixel (the sequence number in the vertical direction). For example, the waveform illustrated in FIG. 13A is used when the column number of the pixel is an odd number, and the waveform illustrated in FIG. 13B is used when the column number of the pixel is an even number.

FIG. 14A illustrates a contrast ratio emphasis parameter that makes the gradation characteristics become an S-shape. Here, the range of S-shape is set from +32 to −32. FIG. 14B illustrates a pattern amplitude parameter that makes the amplitude take a peak in an intermediate gray level. Here, the peak of the amplitude is set to +8. FIG. 14A and FIG. 14B are one-dimensional alignments of 8 bits (256 values (0 through 255)).

The graphs (parameters) in FIG. 13A through FIG. 14B are stored in the data storage unit 26 in FIG. 1. Output pixel values of FIG. 13A through FIG. 14B may be rounded to the whole number for the reason of a process by the processor.

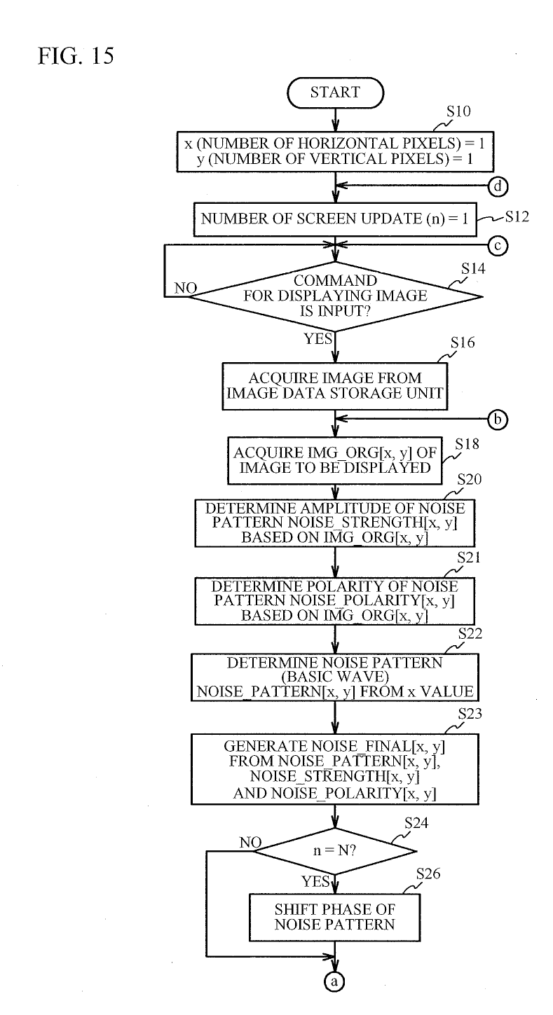

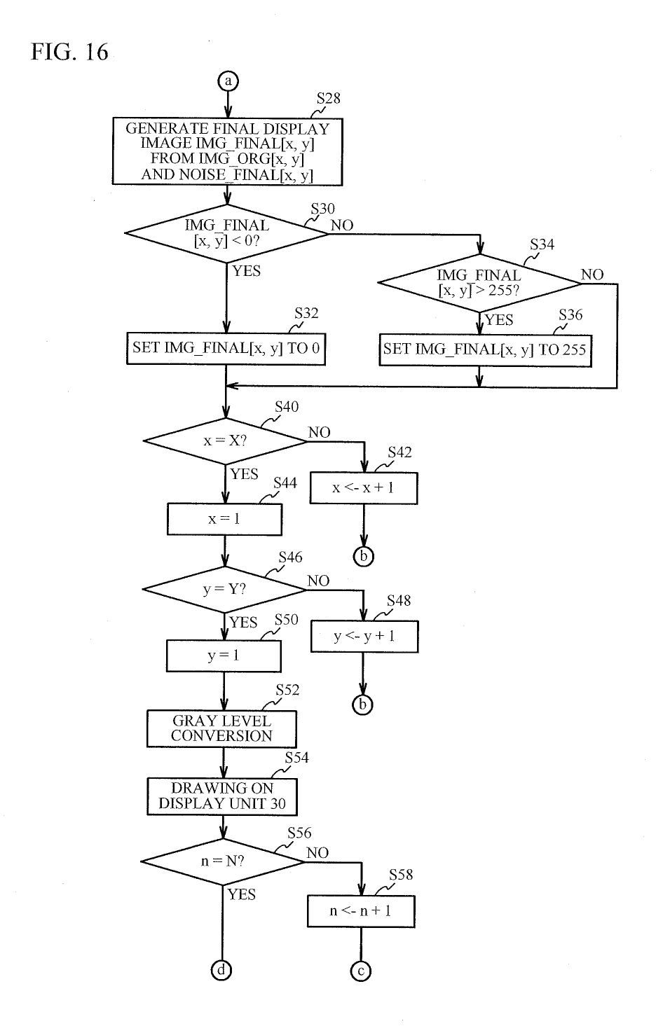

In this embodiment, the process along flowcharts in FIG. 15 and FIG. 16 is executed using basic waveforms and parameters in FIG. 13A through FIG. 14B. The process along flowcharts in FIG. 15 and FIG. 16 is executed by the display control unit 24.

In a step S10 of FIG. 15, the display control unit 24 sets the variable x representing the number of horizontal pixels to 1, and sets the variable y representing the number of vertical pixels to 1. Then, the display control unit 24 sets the variable n representing the number of screen updates to 1 in a step S12.

In a step S14, the display control unit 24 stands by until the command for displaying an image is input. When the command for displaying an image is input, the display control unit 24 acquires the image corresponding to the command from the data storage unit 26 in a step S16.

Then, the display control unit 24 acquires the data of the image to be displayed (input image data) Img_org[x, y] (here, Img_org[1, 1]) in a step S18.

Then the display control unit 24 determines the amplitude of gray level value of the noise pattern Noise_strength[x, y] (here, Noise_strength[1, 1]) from the input image data Img_org[x, y] by using the parameter in FIG. 14B stored in the data storage unit 26 in a step S20. For example, according to FIG. 14B, when Img_org[x, y] is 0, Noise_strength[x, y] becomes 0, and when Img_org[x, y] is 35, Noise_strength[x, y] becomes 1.

Then, the display control unit 24 determines a pattern polarity of the noise pattern Noise_Polarity[x, y] (here, Noise_Polarity[1, 1]) from Img_org[x, y] by using the parameter in FIG. 14A stored in the data storage unit 26. For example, according to FIG. 14A, when Img_org[x, y] is 0, Noise_Polarity[x, y] becomes −32, and when Img_org[x, y] is 35, Noise_Polarity[x, y] becomes −29.

The display control unit 24 determines data of the noise pattern image Noise_pattern[x, y] (here, Noise_pattern[1, 1]) by using FIGS. 13A and 13B in a step S22. When the value of y is an odd number as described previously, the basic waveform illustrated in FIG. 13A is used, and when the value of y is an even number, the basic waveform illustrated in FIG. 13B is used. For example, as y is an odd number in a case of Noise_pattern[1, 1], the basic waveform illustrated in FIG. 13A is used, and the value +4 is obtained.

The execution sequence of steps S20 through S22 may be changed.

Then, the display control unit 24 generates data of the final noise pattern Noise_final[x, y] (here, Noise_final[1, 1]) by using parameters determined in steps S20 through S22 with a following formula (2) in a step S23.

Noise_final[x,y]=Noise_pattern[x,y]×Noise_Polarity[x,y]+Noise_strength[x,y] (2)

In a step S24, the display control unit 24 determines whether n is a maximum value N of n which is preliminarily determined. Here, as n is equal to 1, the determination is NO, and the process moves to a step S28 in FIG. 16. When n is equal to N, as the determination of the step S24 is YES, the display control unit 24 shifts the phase of the noise pattern in the step S26, and the process moves to the step S28 in FIG. 16.

The display control unit 24 generates the data of the final display image (combined image) Img_final[x, y] (here, Img_final[1, 1]) from the data of image to be displayed Img_org[x, y] (here, Img_org[1, 1]) and Noise_final[x, y] (here, Noise_final[1, 1]) based on the following formula (3) in the step S28 in FIG. 16.

Img_final[x,y]=Img_org[x,y]+Noise_final[x,y] (3)

Then, the display control unit 24 determines whether Img_final[x, y] is less than 0 in a step S30. When the determination of the step S30 is YES, as the data of the final display image can not be output, the display control unit 24 sets Img_final[x, y] to the minimum value 0 in a step S32, and moves to a step S40. On the other hand, when the determination of the step S30 is NO, it is determined whether Img_final[x, y] is greater than 255 in a step S34. When the determination of the step S34 is YES, as the data of the final display image cannot be output, the display control unit 24 sets Img_final[x, y] to the maximum value 255 in a step S36, and goes to the step S40. When the determination of the step S34 is NO, the process moves to the step S40.

In the step S40, the display control unit 24 determines whether x is a maximum value X which is preliminarily determined. Here, the maximum value X means the total number of pixels aligned in the horizontal direction on the display unit 30. When the determination of the step S40 is NO, the process moves to a step S42, and the display control unit 24 increments x by one, and goes back to the step S18 in FIG. 15. Then, the display control unit 24 executes the step S18 through step S36, and generates Img_final[2, 1] from Img_org[2, 1]. When the determination of the step S40 is NO again, the display control unit 24 increments x by one again in the step S42 and goes back to the step S18. After that, above procedures are repeated until Img_final[3, 1] through Img_final[X, 1] are obtained. When the determination of the step S40 becomes YES, the process moves to the step S44. The display control unit 24 sets x to 1 in the step S44. Then, in a step S46, it determines whether y is a maximum value Y preliminarily determined. Here, the maximum value Y means the total number of pixels aligned in the vertical direction on the display unit 30. When the determination of the step S46 is NO, the process moves to the step S48, and the display control unit 24 increments y by one and goes back to the step S18 in FIG. 15. After this process, the step S18 through step S42 are repeated with the basic waveform illustrated in FIG. 13B, and Img_final[1, 2] through Img_final[X, 2] are obtained.

Above procedures are repeated, and when the display control unit 24 obtains Img_final[X, Y], the determination of the step S46 becomes YES, and the process moves to a step S50. In the next step S50, the display control unit 24 sets y to 1. Then, the display control unit 24 executes the gray level conversion process for adapting to the characteristic of the display unit 30 by using obtained Img_final[1, 1] through Img_final[X, Y] in a step S52 and carries out the drawing on the display unit 30 in the step S54.

Then, in a step S56, the display control unit 24 determines whether n is N. When the determination of the step S56 is NO, n is incremented by one in a step S58, and the process goes back to the step S54. On the other hand, when n is N, the determination of the step S58 becomes YES, and the process goes back to the step S12 in FIG. 15.

As the display control unit 24 executes above procedures, the image to be displayed (input image) is combined with the noise pattern image of which the amplitude and the polarity are changed according to the input image, and the combined image can be displayed on the display unit 30.

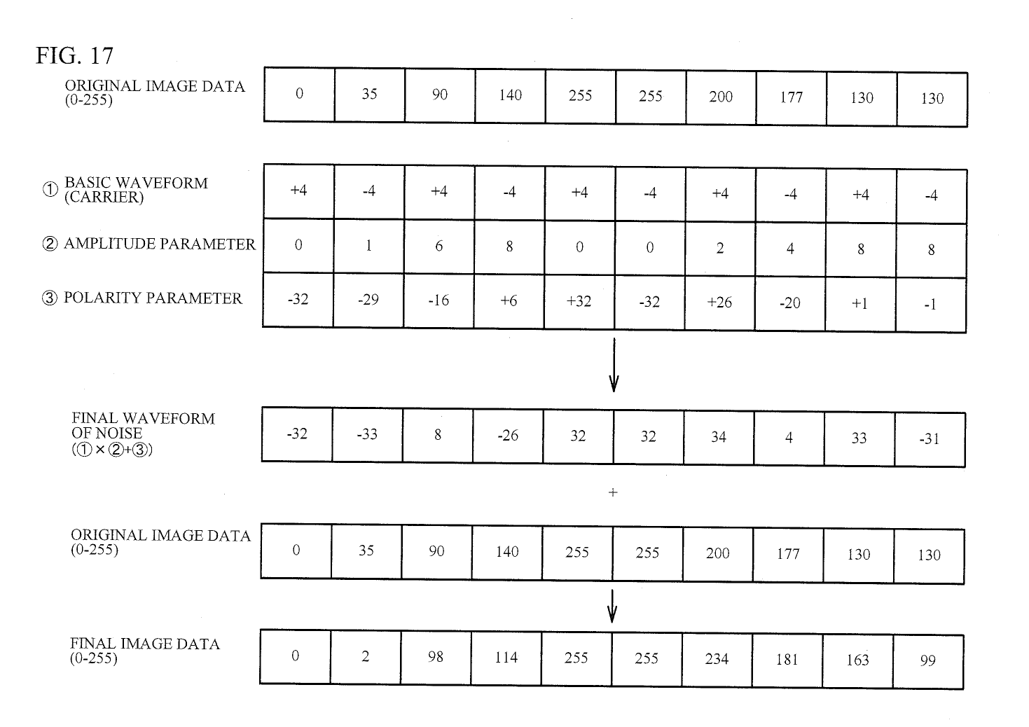

Here, a detail description will be given of the process of the present embodiment by using a case where the image data having the gradation illustrated in FIG. 17 is input as the input image as an example. In order to simplify the description, a case where the number of vertical pixels (y) is 1 is illustrated.

Firstly, the pixel at the left end is processed. In this case, as the gray level value of the left end pixel Img_org[x, y] is 0, the polarity becomes −32 according to FIG. 14B, and the amplitude becomes 0 according to FIG. 14A. The data of the final noise pattern Noise_final[x, y] becomes −32 when calculated from these values and the value +4 of the basic waveform (carrier) in FIGS. 13A and 13B with the above formula (2). In this case, the data of the final display image (combined image) Img_final[x, y] becomes −32 (0+(−32)) from the above formula (3), but this value is less than 0. Therefore, the data of the final display image (combined image) is set to 0.

In the same manner, focusing on the second pixel from the left end, as the gray level value of the image data is 35, the polarity is −29 according to FIG. 14B, and the amplitude is 1 according to FIG. 14A. The data of the final noise pattern Noise_final[x, y] becomes −33 from these values, the value −4 of the basic waveform (carrier) and the above formula (2). Then, the data of the final display image (combined image) Img_final[x, y] becomes 2 (35+(−33)) from the above formula (3).

As the above process is executed to each pixel, the data (gray level value) of the final display image (combined image) corresponding to the data (gray level value) of the input image “0, 35, 90, 140, 255, 255, 200, 177, 130, 130” becomes “0, 2, 98, 114, 255, 255, 234, 181, 163, 99”.

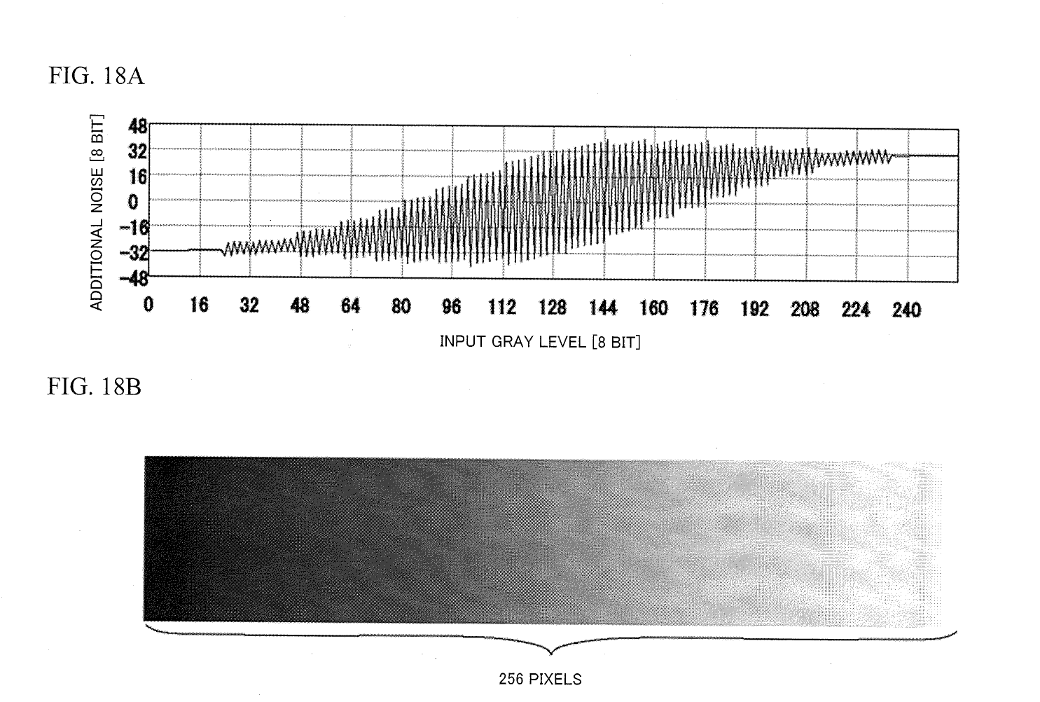

On the other hand, when the process along flowcharts in FIG. 15 and FIG. 16 is executed to the input image (gradation image) illustrated in FIG. 18B, the waveform (image data) illustrated in FIG. 18A is output. As illustrated in FIG. 18A, when the gray level value of the input image data is a dark gray level (shadow), the output image data is corrected to a darker gray level, and when the gray level value of the input image data is a bright gray level (highlight), the output image data is corrected to a brighter gray level by the execution of the process along flowcharts in FIG. 15 and FIG. 16. That is to say, the average curve of the output image data (the curve obtained by averaging the peak at a positive (+) side and the peak at a negative (−) side) becomes nearly an S-shaped curve as illustrated with a dashed line in FIG. 12 although it is not illustrated in FIG. 18A.

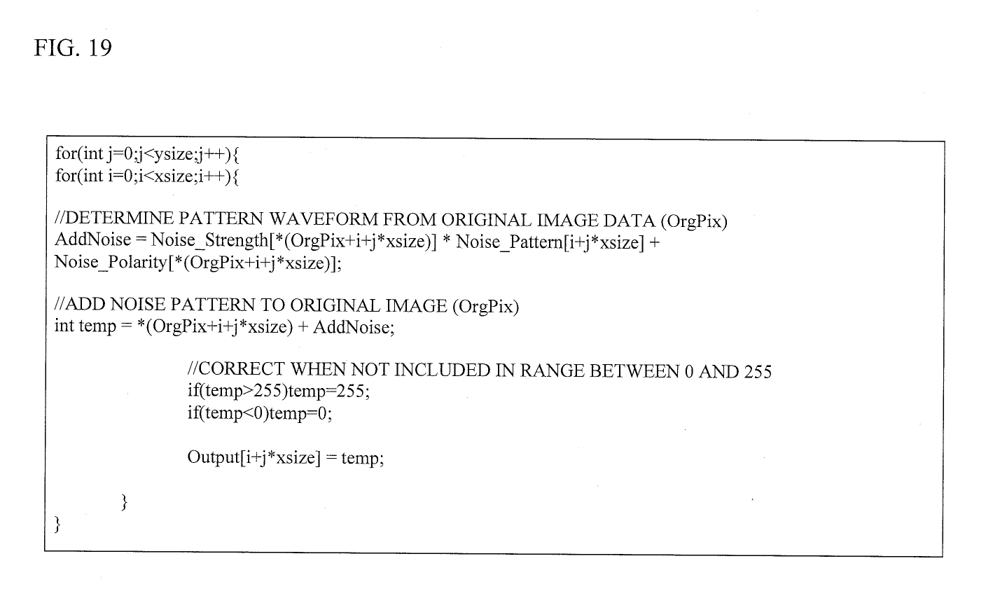

FIG. 19 illustrates a program (C language) for executing a same process of above flowcharts. In this program, “OrgPix” is used instead of “Img_Org” used in flowcharts in FIG. 15 and FIG. 16, “AddNoise” is used instead of “Noise_final”, and “int temp” is used instead of “Img_final”. In addition, “xsize” represents the number of horizontal pixels of the display image, and “ysize” represents the number of vertical pixels of the display image.

It is not necessary to extract the noise pattern (Noise_pattern[x, y]) on a memory. If the noise pattern is a periodic pattern, the formula may be used, and if it is a random pattern, the function generating random numbers may be used.

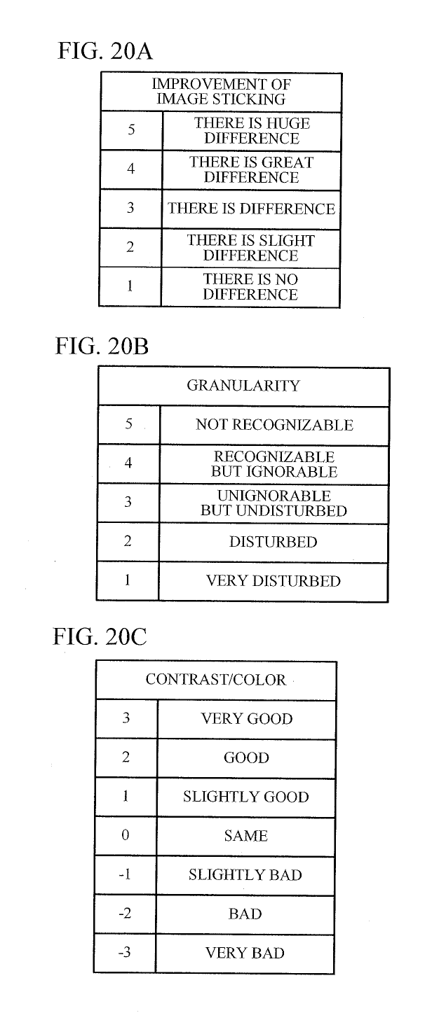

A description will now be given of a subjective evaluation to verify the effect of the present embodiment quantitatively. Evaluation items of this subjective evaluation are three, which are (i) the improvement in image sticking, (ii) the granularity, and (iii) the contrast ratio/color as illustrated in FIG. 20A through FIG. 20C.

In each evaluation item, the high score means the high visual quality. Seven images, which include three kinds of solid images (intermediate gray level), two kinds of person images, a gradation image, and an animation image, are used as evaluation images displayed on the display unit 30. The noise patterns each of which the peak to peak is 1/16 gray levels, 3/16 gray levels, and 6/16 gray levels are used as a noise pattern which is added to the input image data (here, “add” has a same meaning with the words such as “superimpose”, “combine”, and “synthesize”).

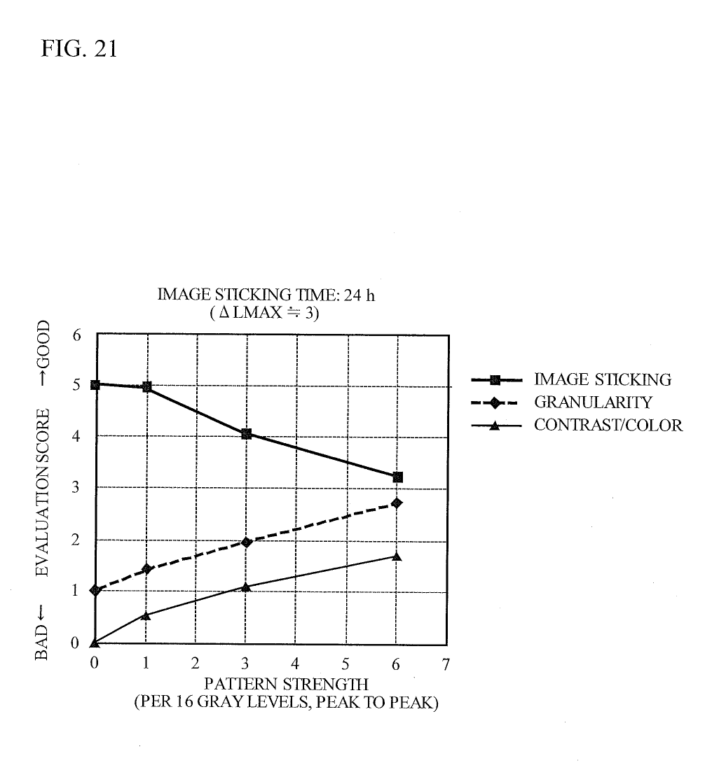

FIG. 21 illustrates results of the subjective evaluation. As illustrated in FIG. 21, when the pattern strength (noise strength) is made larger, it is quantitatively indicated that the granularity slightly decreases, but the image sticking is reduced, and the evaluation score of the contrast ratio/color increases.

As described above in detail, according to the present embodiment, as the display control unit 24 generates the display image data by adding the noise pattern, of which the polarity is in accordance with the gray level value of each pixel of the image data, to the image data, it is possible to generate the display image data (output image data) of which the gray level value of each pixel of the input image is made so that the image sticking is difficult to be identified and the contrast ratio becomes better. According to this, it becomes possible to obscure the image sticking and to make the contrast ratio higher by the gray level correction using the noise pattern, of which the polarity is in accordance with the gray level value of each pixel of image data, in addition to the visual diffusion by the noise pattern itself.

In the present embodiment, as illustrated in FIG. 18, the output is corrected so as to be an S-shaped curve, and it is possible to further improve the contrast ratio of the image data.

In addition, according to the present embodiment, as the display control unit 24 changes the amplitude of the gray level value of the noise pattern based on the pixel value of the display image, it becomes possible to enhance the visual effect of the noise pattern and to obscure the burn-in image by making the amplitude of the gray level value of the noise pattern larger at the part of the pixel value where the image sticking is easily identified.

In addition, according to the present embodiment, as the display control unit 24 changes the phase of the noise pattern according to the number of generations of the display image, it is possible to suppress the image sticking of the noise pattern itself to the display unit 30.

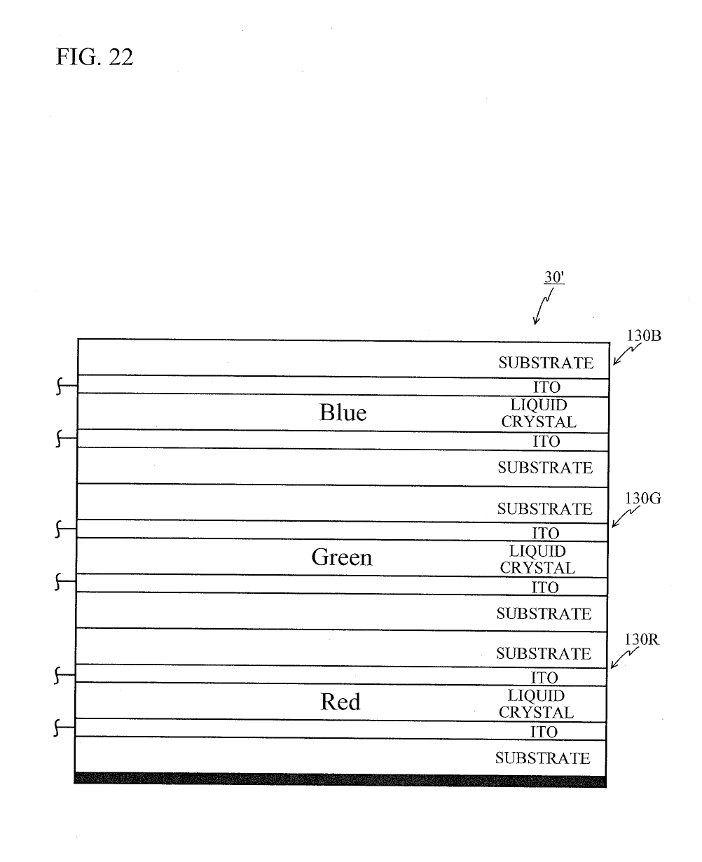

In the above embodiment, the description was given of the case where the liquid crystal display element 10 is the liquid crystal element that displays a monochrome image. However, the liquid crystal display element 10 may be a liquid crystal display element capable of color display. In this case, as illustrated in FIG. 22, a display unit 30′ of the liquid crystal display element is formed by stacking a blue (B) display unit 130B, a green (G) display unit 130G and a red (R) display unit 130R. In the display unit 30′, as the image data given to each pixel of RGB is different, it is necessary to provide the segment drivers 34 for each of RGB.

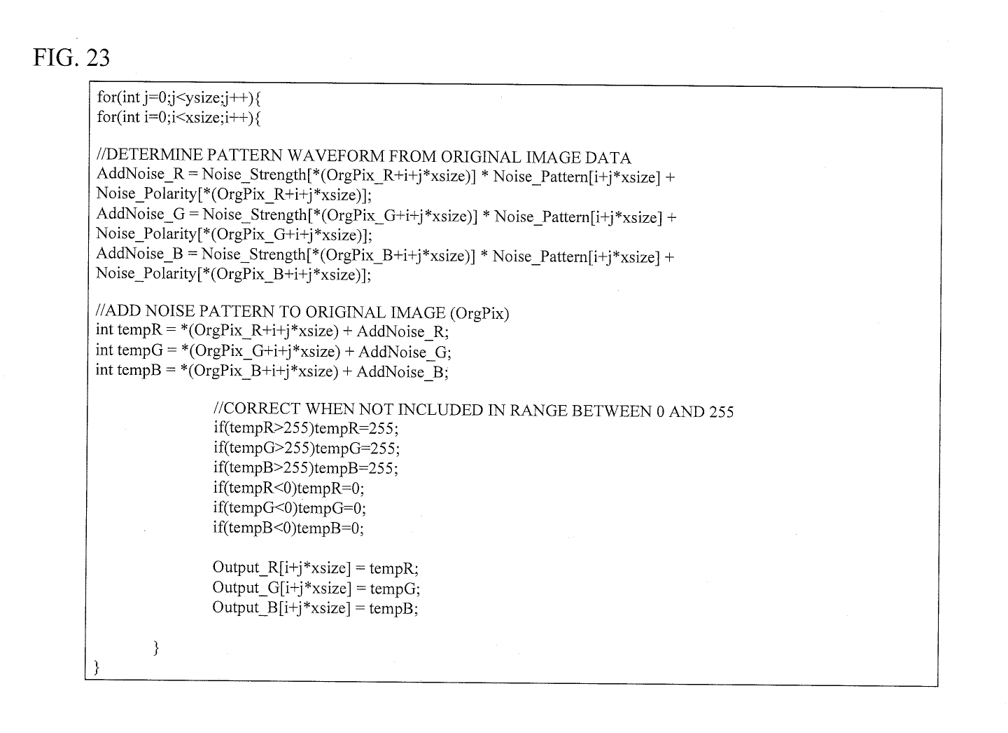

When the liquid crystal display element capable of color display is used, the program (C language) illustrated in FIG. 23 based on FIG. 19 may be used for generating the output image data.

In the above embodiment, the description was given of the case where a periodic pattern is used as a noise pattern, but a noise pattern is not limited to a periodic pattern. For example, it is possible to use a random noise pattern. Same effect as the periodic pattern can be obtained with the random noise pattern, but from the point of view of the granularity, the use of a periodic pattern is preferable.

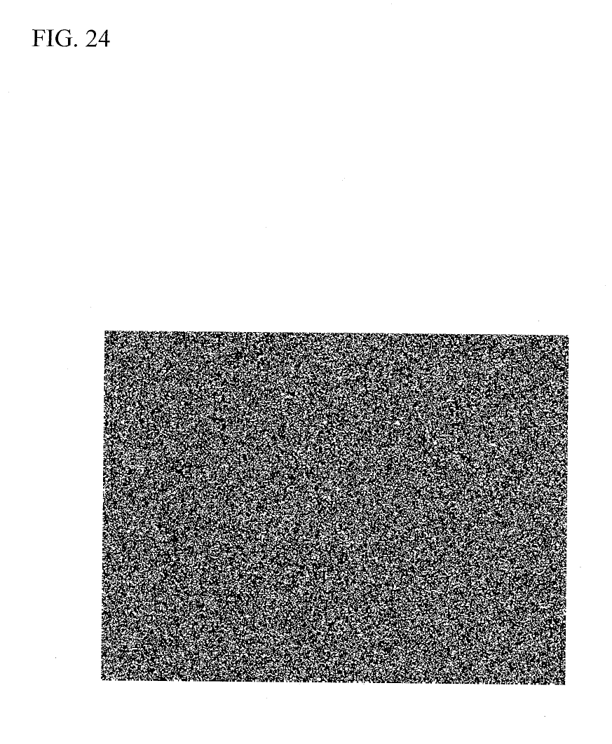

In addition, from the point of view of the visual characteristics, it is verified that the discomfort by the granularity is not easily felt when a check pattern is used as the periodic pattern, or when the blue noise which has a weight on the high frequency side in the space frequency as illustrated in FIG. 24 is used as a random pattern.

In the above embodiment, as illustrated in FIG. 11, the description was given of the case where the image sticking increases as the gray level value of the image is closer to the intermediate gray level, but the case is not limited to above embodiment. When the image sticking is small in a case of highlight or shadow, it may be possible to control the amplitude of the gray level value of the noise pattern other than the highlight or shadow to be large, or to adjust the polarity so that the image data in the intermediate gray level comes closer to the highlight or shadow where the image sticking is small.

When the liquid crystal display element having a panel structure where the image sticking becomes large in the gray level close to the highlight (white) or shadow (black) compared to the intermediate gray level, the amplitude of the gray level value of the noise pattern added to the highlight or shadow may controlled to be large, or the polarity may be changed so that the gray level value of the output image data comes close to the intermediate gray level.

In the above embodiment, the description was given of the case where amplitudes of gray level values of the noise pattern are changed according to pixel values of the image to be displayed, but the amplitude may be a fixed value. In the above embodiment, the description was given of the case where the phase of noise pattern is changed according to the number of updates of image, but a phase may be not changed.

In the above embodiment, the description was given of the case where the present invention is applied to the cholesteric liquid crystal, but the present invention may be applied to the display device capable of maintaining a display without power supply such as an electrophoresis system, electronic powder fluid, and the like.

In the above embodiment, the description was given of a case where the present invention is achieved by the liquid crystal display element 10 as a display device including the display control unit 24 having a function combining a noise pattern with an image, but the present invention can be achieved by a display control program which is installed in a computer system, and which causes a computer system to execute a process in FIG. 14A, FIG. 14B and FIG. 15.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various change, substitutions, and alterations could be made hereto without departing from the spirit and scope of the invention.

What is claimed is:

1. A display device comprising:
a data storage unit that stores image data;
a display image data generation unit that generates display image data by adding a noise pattern, of which a polarity is in accordance with a gray level value of each pixel of the image data, to the image data; and
a display unit that displays an image based on the display image data generated by the display image generation unit.

2. The display device according to claim 1, wherein when the pixel of the image data is a highlight pixel, the display image data generation unit makes a polarity of a pixel of the noise pattern, which is added to the highlight pixel, be a positive polarity, and when the pixel of the image data is a shadow pixel, the display image data generation unit makes a polarity of a pixel of the noise pattern, which is added to the shadow pixel, be a negative polarity, in a case where an amount of image sticking when the gray level value is a highlight or a shadow is smaller than an amount of image sticking when the gray level value is an intermediate gray level.

3. The display device according to claim 1, wherein based on gray level values of pixels of the image data, the display image data generation unit changes amplitudes of gray level values of the noise pattern added to the pixels.

4. The display device according to claim 2, wherein the display image data generation unit changes the amplitudes of the gray level values of the noise pattern image more greatly in a case where the gray level values of the pixels of the image data represent an intermediate gray level than a case where the gray level values of the pixels of the image data represent the highlight or the shadow.

5. The display device according to claim 1, wherein the display unit has memory characteristics.

6. The display device according to claim 5, wherein the display unit uses a liquid crystal that forms a cholesteric phase.

7. The display device according to claim 1, wherein the display image data generation unit changes a phase of the noise pattern image in accordance with the number of generation of the display image data.

8. A computer readable medium storing a program causing a computer to execute a process, the process comprising:
generating display image data by adding a noise pattern data, of which a polarity is in accordance with a gray level value of each pixel of an image data to be displayed, to the image data; and
displaying an image on a display unit based on the generated display image data.

9. The computer readable medium according to claim 8, wherein when the pixel of the image data is a highlight pixel, a polarity of a pixel of the noise pattern, which is added to the highlight pixel, is made to be a positive polarity in the generating, and when the pixel of the image data is a shadow pixel, a polarity of a pixel of the noise pattern, which is added to the shadow pixel, is made to be a negative polarity in the generating, in a case where an amount of image sticking when the gray level value is a highlight or a shadow is smaller than an amount of image sticking when the gray level value is an intermediate gray level.
